(19) United States
(12) Patent Application Publication
(10) Pub. No.: US 2011/0203260 A1
(43) Pub. Date: Aug. 25, 2011

(54) EXHAUST PURIFICATION SYSTEM OF INTERNAL COMBUSTION ENGINE

(75) Inventors: Kazuhiro Umemoto, Susono-shi (JP); Kohei Yoshida, Gotenba-shi (JP); Hiromasa Nishioka, Susono-shi (JP); Yuka Nakata, Susono-shi (JP); Takamitsu Asanuma, Mishima-shi (JP)

(73) Assignee: TOYOTA JIDOSHA KABUSHIKI KAISHA, Toyota-shi, Aichi (JP)

(21) Appl. No.: 13/124,767

(22) PCT Filed: Nov. 2, 2009
(86) PCT No.: PCT/JP2009/069024

§ 371 Date: Apr. 18, 2011

(30) Foreign Application Priority Data
Nov. 7, 2008 (JP) 2008-286426

(51) Int. Cl. F01N 3/035; F01N 3/10; F02M 25/06

(52) U.S. Cl. 60/278; 60/301; 60/297; 60/285

(57) ABSTRACT

An exhaust purification system of an internal combustion engine arranging in an engine exhaust passage an NOx storing reducing catalyst storing NOx contained in exhaust gas when an air-fuel ratio of inflowing exhaust gas is lean and reducing and purifying stored NOx when the air-fuel ratio of the inflowing exhaust gas becomes a stoichiometric air-fuel ratio or rich, which system is provided with an NOx production reducing means for reducing an amount of production of NOx produced in a combustion chamber due to change of a combustion state of the engine and temporarily reduces the amount of production of NOx by the NOx production reducing means when an amount of N₂O flowing out from the NOx storing reducing catalyst is anticipated to exceed an allowable amount.

### TECHNICAL FIELD

The present invention relates to an exhaust purification system of an internal combustion engine.

### BACKGROUND ART

In an exhaust purification system of an internal combustion engine provided with an NOx storing reducing catalyst storing NOx contained in exhaust gas when an air-flow ratio of inflowing exhaust gas is lean and reducing and purifying the stored NOx when the air-flow ratio of the inflowing exhaust gas becomes a stoichiometric air-fuel ratio or rich, when reducing and purifying the stored NOx, sometimes N₂O is produced together with the N₂ and O₂. N₂O is known to cause a greenhouse effect by a mechanism similar to CO₂ when released into the atmosphere, so it is desirable to suppress the emission of the same so as to suppress global warming.

Known in the art is an exhaust purification system of an internal combustion engine designed to raise a catalyst temperature and then perform treatment for reducing and purifying the NOx if the estimated amount of N₂O is a predetermined amount or more when reducing and purifying stored NOx so as to suppress the amount of exhaust of N₂O (see Japanese Patent Publication (A) No. 2004-211676).

However, additional fuel is required for the treatment for raising the catalyst temperature. From the viewpoint of fuel economy, the smaller the additional fuel the better. In particular, when the temperature of the exhaust gas is low, it is never desirable that the fuel required for raising the temperature be increased.

### SUMMARY OF INVENTION

The present invention was made in consideration of the above problem and has as its object the provision of an exhaust purification system of an internal combustion engine suppressing the amount of fuel additionally used while suppressing the amount of production of N₂O.

In a first aspect of the present invention, there is provided an exhaust purification system of an internal combustion engine arranging in an engine exhaust passage an NOx storing reducing catalyst storing NOx contained in exhaust gas when an air-fuel ratio of inflowing exhaust gas is lean and reducing and purifying stored NOx when the air-fuel ratio of the inflowing exhaust gas becomes a stoichiometric air-fuel ratio or rich, which exhaust purification system of an internal combustion engine is provided with an NOx production reducing means for reducing an amount of production of NOx produced in a combustion chamber due to change of a combustion state of the engine and temporarily reduces the amount of production of NOx by the NOx production reducing means at least when an amount of N₂O produced at the NOx storing reducing catalyst is anticipated to exceed an allowable amount.

Further, in a second aspect of the present invention, there is provided an exhaust purification system of an internal combustion engine arranging in an engine exhaust passage an NOx storing reducing catalyst storing NOx contained in exhaust gas when an air-fuel ratio of inflowing exhaust gas is lean and reducing and purifying stored NOx when the air-fuel ratio of the inflowing exhaust gas becomes a stoichiometric air-fuel ratio or rich, which exhaust purification system of an internal combustion engine is provided with an NOx production reducing means for reducing an amount of production of NOx produced in a combustion chamber due to change of a combustion state of the engine and temporarily reduces the amount of production of NOx by the NOx production reducing means at least when a catalyst temperature of the NOx storing reducing catalyst is within an N₂O production temperature range at least in a period where the air-fuel ratio of the exhaust gas flowing into the NOx storing reducing catalyst is switched from lean to rich and a period in which it is switched from rich to lean.

That is, in the first and second aspects of the present invention, as the method of suppressing the amount of production of N₂O, the method of reducing the amount of production of NOx, one of the causes of production, is employed. Therefore, a method of suppression of the amount of production of N₂O suppressing the amount of additionally used fuel required for raising the temperature of the catalyst like in the conventional method and extremely desirable from the viewpoint of fuel consumption can be realized. Note that, the ratio of the air and fuel (hydrocarbons) supplied into the engine intake passage, combustion chamber, and exhaust passage upstream of the NOx storing reducing catalyst is referred to as the “air-fuel ratio of the exhaust gas”.

Further, in a third aspect of the present invention, there is provided an exhaust purification system of an internal combustion engine of the second aspect of the invention in which in the period at which the air-fuel ratio of the exhaust gas flowing into the NOx storing reducing catalyst is switched from lean to rich to the period in which it is switched from rich to lean, when the catalyst temperature of the NOx storing reducing catalyst is within an N₂O production temperature range, the NOx production reducing means temporarily reduces the amount of production of NOx.

Further, in a fourth aspect of the present invention, there is provided an exhaust purification system of an internal combustion engine as set forth in the second aspect of the invention in which in the period at which the air-fuel ratio of the exhaust gas flowing into the NOx storing reducing catalyst is switched from lean to rich and the period in which it is switched from rich to lean, when the catalyst temperature of the NOx storing reducing catalyst is within an N₂O production temperature range, the NOx production reducing means temporarily reduces the amount of production of NOx and, between these periods, the NOx production reducing means does not temporarily reduce the amount of production of NOx.

Further, in a fifth aspect of the present invention, there is provided an exhaust purification system of an internal combustion engine as set forth in any one of the first to fourth aspects of the invention wherein the system is further provided with an intake flow adjusting means for adjusting an intake flow to the inside of a combustion chamber and forming an optimum disturbance of gas in accordance with an engine operating state inside the combustion chamber and the NOx production reducing means controls the intake flow adjusting means to form a disturbance different from the optimum disturbance of the gas and thereby reduce the amount of production of NOx produced in the combustion chamber.

That is, in the fifth aspect of the present invention, if forming a disturbance different from the optimum disturbance of the gas in the combustion chamber, the combustion will become incomplete compared with the case where the optimum gas disturbance is formed. As a result, compared with the case where the optimum gas disturbance is formed, the maximum temperature at the time of combustion also becomes lower, the production of NOx is suppressed, and the amount of production of N₂O can be suppressed. This is because NOx increases in amount of production the higher the maximum temperature at the time of combustion.

Further, in a sixth aspect of the present invention, there is provided an exhaust purification system of an internal combustion engine as set forth in the fifth aspect of the invention wherein the system further arranges in the engine exhaust passage an oxidation catalyst and a particulate filter for trapping particulate matter in the exhaust gas, and the NOx production reducing means controls the intake flow adjusting means, forms a disturbance reduced from the optimum disturbance of the gas, and traps the particulate matter in the exhaust gas increased due to combustion due to the disturbance by the particulate filter.

That is, in the sixth aspect of the present invention, the disturbance reduced from the optimum disturbance of the gas is used to make the fuel burn. As a result, due to the smaller disturbance, the oxygen required for the combustion is insufficient, and the maximum temperature at the time of combustion becomes lower compared with the case where the optimum gas disturbance is formed. As a result, the production of NOx is suppressed and the amount of production of N₂O can be suppressed. However, along with this, the amount of particulate matter contained in the exhaust gas increases. In this case, a particulate filter is arranged in the exhaust passage whereby emission of particulate matter into the atmosphere is prevented.

Further, in a seventh aspect of the present invention, there is provided an exhaust purification system of an internal combustion engine as set forth in the sixth aspect of the invention wherein at the time of activation of the oxidation catalyst, the NOx production reducing means controls the intake flow adjusting means, forms a disturbance increased from the optimum disturbance of the gas, and oxidizes the hydrocarbons in the exhaust gas increased due to combustion by that disturbance by the oxidation catalyst.

That is, in the seventh aspect of the present invention, the disturbance increased from the optimum disturbance of the gas is used to make the fuel burn. As a result, due to the overly large disturbance, combustion becomes unstable. Compared to the case where the optimum gas disturbance is formed, the maximum temperature at the time of combustion also becomes lower. As a result, the production of NOx is suppressed and the amount of production of N₂O can be suppressed. However, along with this, the amounts of hydrocarbons (HC) and carbon monoxide (CO) contained in the exhaust gas increase. In this case, by arranging an oxidation catalyst in the exhaust passage, these are oxidized and the exhaust of HC or CO into the atmosphere is prevented.

Further, in an eighth aspect of the present invention, there is provided an exhaust purification system of an internal combustion engine as set forth in any one of the first to seventh aspects of the invention wherein the system is further provided with an exhaust gas recirculation passage for recirculating part of the exhaust gas in the engine exhaust passage to the engine intake passage and the NOx production reducing means reduces the amount of production of NOx produced in the combustion chamber due to the increase in the amount of exhaust gas recirculated to the combustion chamber.

That is, in the eighth aspect of the present invention, due to the increase in the amount of exhaust gas recirculated, the maximum temperature at the time of combustion also becomes lower, finally, the amount of NOx flowing into the NOx storing reducing catalyst is also suppressed, and the amount of production of N₂O can be suppressed.

Further, in a ninth aspect of the present invention, there is provided an exhaust purification system of an internal combustion engine as set forth in any one of the first to eighth aspects of the invention wherein the system is further provided with a fuel injecting means for injecting fuel into a combustion chamber and an injection pressure adjusting means for adjusting the fuel injection pressure of the fuel injecting means, and the NOx production reducing means controls the injection pressure adjusting means and lowers the fuel injection pressure so as to reduce the amount of production of NOx produced in the combustion chamber.

That is, in the ninth aspect of the present invention, by reducing the fuel injection pressure, the fuel becomes insufficiently atomized. As a result, combustion becomes incomplete compared with the case of injection by normal fuel injection pressure. As a result, the maximum temperature at the time of combustion also becomes lower, the production of NOx is suppressed, and the amount of production of N₂O can also be suppressed.

Further, in a 10th aspect of the present invention, there is provided an exhaust purification system of an internal combustion engine as set forth in any one of the first to the ninth aspects of the invention wherein the system is further provided with a fuel injecting means for injecting fuel into a combustion chamber and a division adjusting means for dividing the fuel which the fuel injecting means should inject for each engine cycle into a plurality of injections, and the NOx production reducing means reduces the amount of production of NOx produced inside the combustion chamber by controlling the division adjusting means and dividing the fuel to be injected every engine cycle into a plurality of injections.

That is, in the 10th aspect of the present invention, by injecting the fuel to be injected divided into a plurality of injections, the combustion time becomes longer compared with the case of injecting the fuel by a single injection. As a result, the maximum temperature at the time of combustion becomes lower, the production of NOx is suppressed, and the amount of production of N₂O can be suppressed.

### BRIEF DESCRIPTION OF DRAWINGS

These and other objects and features of the present invention will become clearer from the following description of the preferred embodiments given with reference to the attached drawings, wherein:

FIG. 1 is an overview of an internal combustion engine;

FIG. 2 is a cross-sectional view of a surface part of a catalyst carrier of an NOx storing reducing catalyst;

FIG. 3 is a view of results of an experiment showing changes in concentrations of different ingredients;

FIG. 4 is a view showing the relationship between an air-fuel ratio of exhaust gas flowing into an NOx storing reducing catalyst and a period for performing NOx production reducing control;

FIG. 5 is a schematic view of an intake port, intake branch tubes, and swirl control valve;

FIGS. 6a and 6b are schematic views of an intake port, intake branch tube, and swirl control valve;

FIG. 7 is a view showing a map of a stored NOx amount NOXA;

FIG. 8 is a flow chart of an NOx reduction purification operation;

FIG. 9 is a flow chart of a rich processing operation;

FIG. 10 is a flow chart of a rich processing operation;

FIG. 11 is an overview of an internal combustion engine;

FIG. 12 is a flow chart of a rich processing operation; and

FIGS. 13a and 13b are views showing a change in amount of lift of a needle.

### DESCRIPTION OF EMBODIMENTS

Below, referring to the drawings, an exhaust purification system of the present invention will be explained. In the embodiments shown below, the case of application of the present invention to a compression ignition type internal combustion engine is shown. However, the present invention can also be applied to a spark ignition type internal combustion engine.

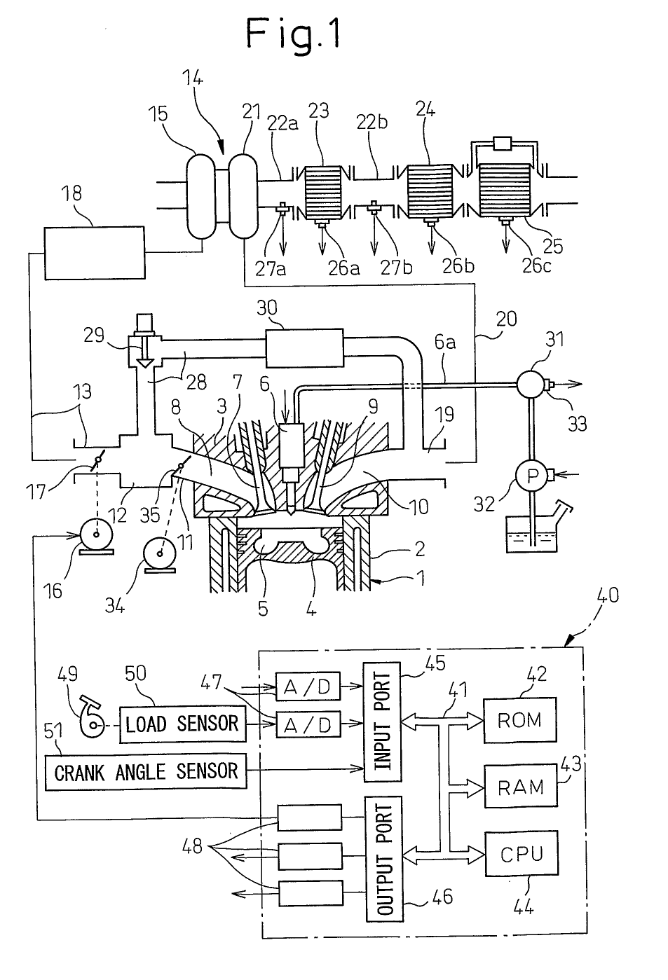

Referring to FIG. 1, 1 indicates an engine body, 2 a cylinder block, 3 a cylinder head, 4 a piston, 5 a combustion chamber, 6 an electrically controlled fuel injector, 7 an intake valve, 8 an intake port, 9 an exhaust valve, and 10 an exhaust port. The intake port 8 is connected through a corresponding intake branch tube 11 to a surge tank 12. The surge tank 12 is connected through an intake duct 13 to a compressor 15 of an exhaust turbocharger 14.

Inside the intake duct 13, a throttle valve 17 driven by a throttle valve drive actuator 16 is arranged. Further, around the intake duct 13, a cooling device 18 for cooling the intake air flowing through the inside of the intake duct 13 is arranged. In the internal combustion engine shown in FIG. 1, engine cooling water is led inside the cooling device 18 and this engine cooling water is used to cool the intake air. On the other hand, the exhaust port 10 is connected through an exhaust manifold 19 and exhaust tube 20 to an exhaust turbine 21 of an exhaust turbocharger 14. An outlet of the exhaust turbine 21 is connected through an exhaust tube 22a to an inlet of an oxidation catalyst 23. An outlet of the oxidation catalyst 23 is connected through an exhaust tube 22b to an inlet of an NOx storing reducing catalyst 24. An outlet of the NOx storing reducing catalyst 24 is connected to an inlet of a particulate filter 25. The oxidation catalyst 23, NOx storing reducing catalyst 24, and particulate filter 25 respectively have temperature sensors 26a, 26b, and 26c for detecting the temperatures Tc, Tn, and Tp attached to them. Further, the exhaust tubes 22a and 22b have air-fuel ratio sensors 27a and 27b for detecting the air-fuel ratios attached to them.

The exhaust manifold 19 and surge tank 12 are connected to each other through an exhaust gas recirculation (below, called “EGR”) passage 28. Inside the EGR passage 28, an electrically controlled EGR control valve 29 is arranged. Further, around the EGR passage 28, an EGR gas cooling device 30 is arranged for cooling the EGR gas flowing through the inside of the EGR passage 28. In the internal combustion engine shown in FIG. 1, engine cooling water is led into the EGR gas cooling device 30 where this engine cooling water is used to cool the EGR gas.

On the other hand, each fuel injector 6 is connected through a fuel feed tube 6a to a fuel reservoir, that is, a common rail 31. This common rail 31 is fed with fuel from an electrically controlled variable discharge fuel pump 32. The fuel fed to the inside of the common rail 31 is fed through the fuel feed tubes 6a to the fuel injectors 6. The common rail 31 has a fuel pressure sensor 33 attached to it for detecting a fuel pressure in the common rail 31. Based on an output signal of the fuel pressure sensor 33, the discharge rate of the fuel pump 32 is controlled so that the fuel pressure inside the common rail 31 becomes a target fuel pressure.

Inside the intake branch tube 11, a swirl control valve (SCV) 35 driven by a swirl control valve drive actuator 34 is further arranged.

An electronic control unit (ECU) 40 is comprised of a digital computer provided with components connected to each other by a bidirectional bus 41 such as a ROM (read only memory) 42, RAM (random access memory) 43, CPU (microprocessor) 44, input port 45, and output port 46. The output signals of the temperature sensors 26a, 26b, and 26c, the air-fuel ratio sensors 27a and 27b, and the fuel pressure sensor 33 are input through the corresponding AD converters 47 to the input port 45.

An accelerator pedal 49 has a load sensor 50 connected to it for generating an output voltage proportional to an amount of depression of the accelerator pedal 49. The output voltage of the load sensor 50 is input through the corresponding AD converter 47 to the input port 45. Further, the input port 45 has a crank angle sensor 51 connected to it for generating an output pulse every time the crankshaft rotates by for example 30°. On the other hand, the output port 46 is connected through corresponding drive circuits 48 to the fuel injectors 6, throttle valve drive actuator 16, EGR control valve 29, fuel pump 32, and swirl control valve drive actuator 34.

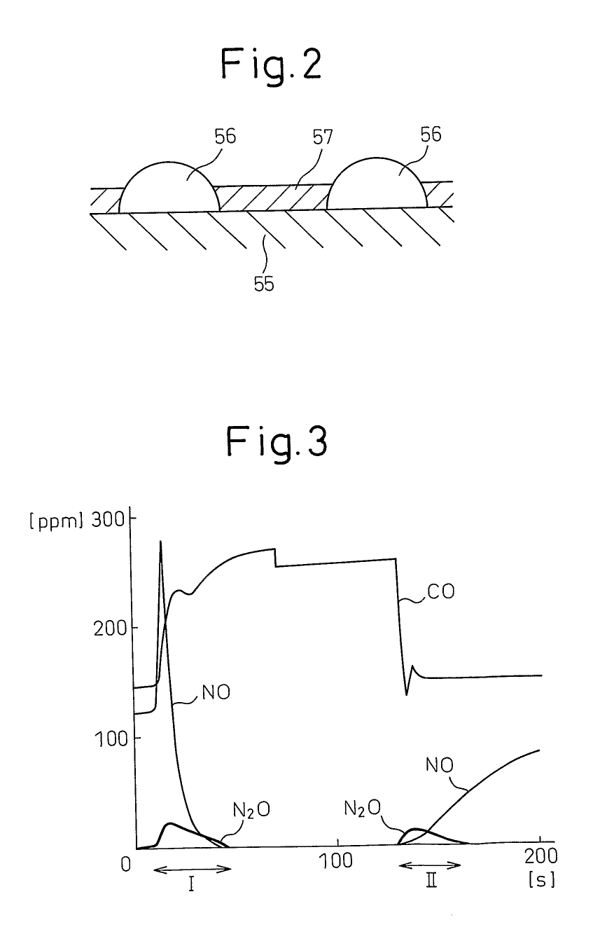

First of all, the NOx storing reducing catalyst 24 shown in FIG. 1 will be explained. This NOx storing reducing catalyst 24 has a catalyst carrier made of for example alumina. FIG. 2 illustrates a cross-section of the surface part of this catalyst carrier 55. As shown in FIG. 2, on the surface of the catalyst carrier 55, the precious metal catalyst 56 is carried dispersed. Further, on the surface of the catalyst carrier 55, a layer of an NOx absorbent 57 is formed.

In the embodiment according to the present invention, as the precious metal catalyst 56, platinum Pt is used. As the ingredient forming the NOx absorbent 57, for example, at least one ingredient selected from potassium K, sodium Na, cesium Cs, and other such alkali metals, barium Ba, calcium Ca, and other such alkali earths, and lanthanum La, yttrium Y, and other such rare earths is used.

If referring to the ratio of the air and fuel (hydrocarbons) fed into the engine intake passage, combustion chamber 5, and exhaust passage upstream of the NOx storing reducing catalyst 24 as the air-fuel ratio of the exhaust gas, the NOx absorbent 57 absorbs NOx when the air-fuel ratio of the exhaust gas is lean and reduces and releases the absorbed NOx when the air-fuel ratio of the exhaust gas is rich for an NOx absorption and release action. However, if continuously burning fuel under a lean air-fuel ratio, eventually the NOx absorption ability of the NOx absorbent 57 ends up becoming saturated and the NOx absorbent 57 can no longer absorb NOx. Therefore, in this embodiment of the present invention, before the absorption ability of the NOx absorbent 57 becomes saturated, the air-fuel ratio of the exhaust gas is temporarily made rich to thereby make the NOx absorbent 57 reduce and release the NOx.

In this regard, as explained above, at the time of reduction and purification of the NOx stored by the NOx storing reducing catalyst, sometimes N₂O is produced together with N₂ and O₂. Specifically, it was learned that when the three conditions of (1) the air-fuel ratio of the exhaust gas being the stoichiometric air-fuel ratio or a rich air-fuel ratio near the stoichiometric air-fuel ratio, (2) the catalyst temperature being a relatively low temperature (200° C. to 350° C.), and (3) the inflowing NOx amount being relatively large (below, referred to as “N₂O production conditions”) are satisfied, part of the NOx is changed to N₂O, the amount of production of N₂O is increased, and the allowable amount is exceeded.

FIG. 3 shows the results of an experiment showing the change in concentrations of the various types of ingredients at the time of reduction and purification of the NOx stored in the NOx storing reducing catalyst. This shows the situation when the temperature of the NOx storing reducing catalyst is made a relatively low temperature (200° C. to 350° C.) of the condition (2) (below, this temperature region being referred to as the “N₂O production temperature range”) and, in that state, changing the air-fuel ratio of the exhaust gas flowing into the NOx storing reducing catalyst from lean to rich, holding it, then returning it from rich to lean.

The abscissa plots the time (unit: seconds [s]), while the ordinate plots the concentration (unit: [ppm]). The amount of CO flowing into the NOx storing reducing catalyst along with the elapse of time and the amount of NO and amount of N₂O amount flowing out from the NOx storing reducing catalyst are shown. The period during which the CO increases shows the state when changing the combustion conditions to increase the unburned fuel HC and the air-fuel ratio of the exhaust gas becomes rich. If referring to FIG. 3, in the period I where the CO flowing into the NOx storing reducing catalyst rapidly increases, that is, the period where the air-fuel ratio of the exhaust gas switches from lean to rich, and the period II where the CO flowing into the NOx storing reducing catalyst rapidly decreases, that is, the period where the air-fuel ratio of the exhaust gas switches from lean to rich, the amount of N₂O amount increases and exceeds the allowable amount.

Therefore, in at least the periods I and II, it is necessary to suppress the amount of N₂O. As explained above, in the past, the practice had been to suppress the amount of N₂O by raising the catalyst temperature and thereby prevent the above condition (2) from being satisfied, but additional fuel is required for this, so this is not desirable from the viewpoint of fuel economy.

Therefore, in the present invention, if it is anticipated that the amount of N₂O will exceed the allowable amount, the amount of NOx flowing into the NOx storing reducing catalyst of the above condition (3), that is, the amount of NOx produced due to combustion in the combustion chamber, is reduced so as to suppress the amount of production of N₂O.

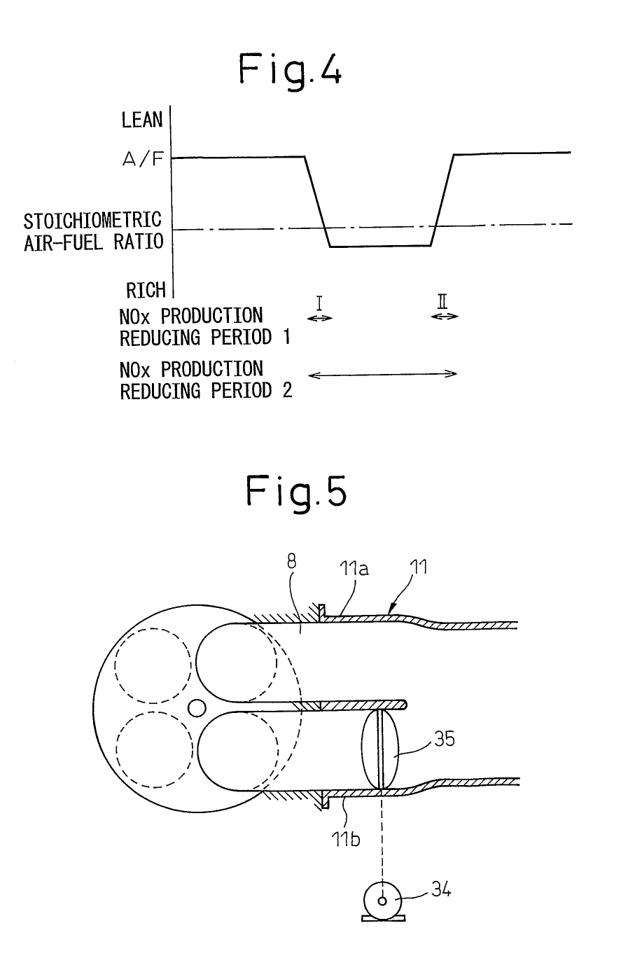

FIG. 4 shows the relationship between the air-fuel ratio of the exhaust gas flowing into the NOx storing reducing catalyst 24 and the period for performing the NOx production reducing control for reducing the amount of production of NOx explained later. From the experimental results shown in FIG. 3, in the period I when the air-fuel ratio of the exhaust gas flowing into the NOx storing reducing catalyst 24 is switched from lean to rich and in the period II when it is switched from lean to rich, the allowable amount is exceeded, so the period for NOx production reducing control is executed for a period including at least the same. That is, the NOx production reducing control explained below, as shown in the NOx production reducing period 1 shown in FIG. 4, may be performed divided into periods including the periods where the air-fuel ratio is switched such as in the period I and period II shown in FIG. 3. In other words, between these periods I and II, the NOx production reducing control is not performed. Further, as shown by the NOx production reducing period 2, it may be performed over the period during which the air-fuel ratio of the exhaust gas is made rich.

Below, the processing for making the air-fuel ratio of the exhaust gas temporarily rich as shown in FIG. 4 will be referred to as “rich processing”. The “rich processing” is performed by mainly injecting fuel for adjusting the air-fuel ratio of the exhaust gas during the expansion stroke of combustion by fuel injection performed near top dead center of compression for obtaining output from an internal combustion engine. Further, rich processing normally performed without consideration of the amount of production of NOx will be referred to as “normal rich processing”, while rich processing performing NOx production reducing control and suppressing the amount of N₂O will be referred to as “N₂O production suppression rich processing”. NOx production reducing control is performed during the N₂O production suppression rich processing at the NOx production reducing period 1 or NOx production reducing period 2 shown in FIG. 4.

Below, the NOx production reducing control and N₂O production suppression rich processing according to the present invention will be explained in detail.

In the first embodiment shown in FIG. 1, as the NOx production reducing control, the intake flow in the combustion chamber is controlled and the disturbance of the gas in the combustion chamber is adjusted to reduce the NOx amount. At the time of combustion, suitable disturbance is required in the combustion chamber for formation of an air-fuel mixture and promotion of combustion. If forming a disturbance different from the optimum disturbance of the gas in the combustion chamber, the combustion becomes incomplete compared with the case where the optimum disturbance of the gas is formed. As a result, compared with the case where the optimum gas disturbance is formed, the maximum temperature at the time of combustion also becomes lower, the production of NOx is reduced, and the amount of production of N₂O can be suppressed.

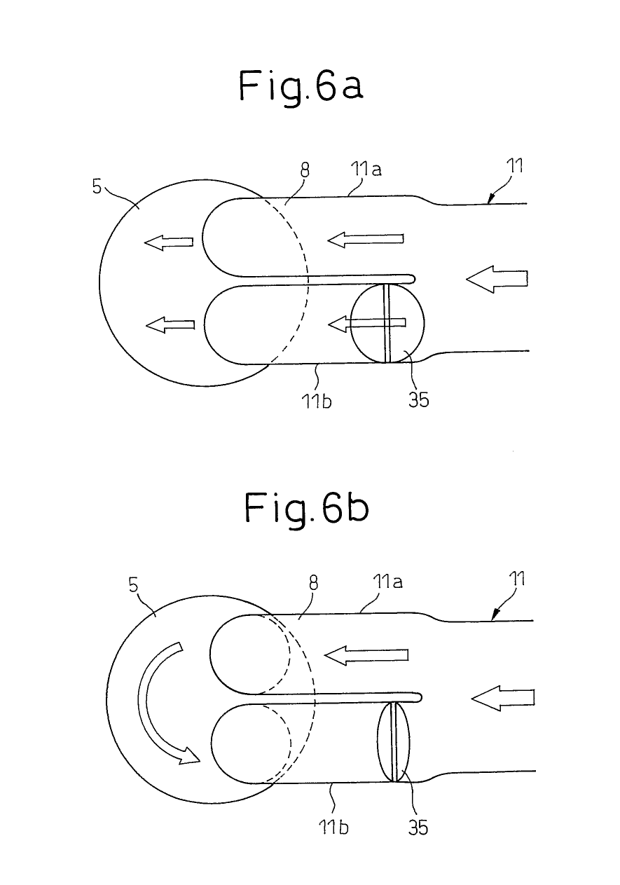

In the present embodiment, to adjust the disturbance of the gas in the combustion chamber, the method of adjusting the swirl ratio (number of turns of swirl per rotation of crankshaft) is used. For this reason, first, the swirl control valve 35 used for changing the swirl ratio will be explained while referring to FIG. 5, FIGS. 6a and 6b.

FIG. 5 is a schematic view of an intake port 8 and intake branch tube 11 connected to one cylinder. Referring to FIG. 5, the intake branch tube 11 is split at its downstream side into the two branch tubes 11a and 11b. The branch tubes 11a and 11b communicate with single intake ports 8. Further, the two intake ports 8 communicated with the branch tubes 11a and 11b communicate with the same cylinder.

In one of the two branch tubes 11a and 11b, that is, the branch tube 11b, the swirl control valve 35 is provided. The swirl control valve 35 can control the flow rate of the air passing through the inside of the branch tube 11b and along with this can adjust the strength of the swirl (swirling flow) formed in the combustion chamber 5.

FIG. 6a shows the flow of air into the combustion chamber 5 when fully opening the swirl control valve 35, while FIG. 6b shows the flow of air into the combustion chamber 5 when fully closing the swirl control valve 35. The arrow marks in the figure show the flow of air. As shown in FIG. 6a, when the swirl control valve 35 is fully open, air flows into both branch tubes 11a and 11b and therefore approximately the same amounts of air flow from the two intake ports 8 into the combustion chamber 5. At this time, the air flowing from one intake port 8 interferes with the air flowing from another intake port 8, so a swirl is almost never caused in the combustion chamber 5.

On the other hand, as shown in FIG. 6b, when the swirl control valve 35 is fully closed, air does not flow into the branch tube 11b. Therefore, air flows into the combustion chamber 5 only from the branch tube 11a not provided with the swirl control valve 35. The air flowing into the combustion chamber 5 tries to flow along the inside walls of the combustion chamber 5, so inside the combustion chamber 5, a turning flow of air such as shown in FIG. 6b, that is, a swirl, is produced.

Further, as will be understood from FIG. 6b, if closing the swirl control valve 35, air can only flow through one of the two branch tubes 11a and 11b, that is, the branch tube 11a. Therefore, the passage through which the air can pass is narrowed. That is, by changing the opening degree of the swirl control valve 35, the flow rate of air passing through the intake branch tube 11 is changed and, as a result, the amount of intake air fed into the combustion chamber 5 is changed. In particular, in the present embodiment, the swirl control valve 35 can be continuously controlled between the fully open and fully closed positions, so by controlling the opening degree of the swirl control valve 35, it is possible to continuously change the amount of intake air fed into the combustion chamber 5, that is, the swirl ratio (number of turns of swirl per rotation of the crankshaft).

Usually, the swirl ratio is determined in advance in accordance with the operating conditions based on a map shown by the engine speed, engine load, etc. and the swirl control valve 35 is controlled to the optimum swirl ratio. Therefore, in the present embodiment, by changing this swirl ratio to a value different from the optimum swirl ratio, the amount of NOx produced by combustion in the combustion chamber is reduced.

That is, at the optimum swirl ratio for the combustion conditions, the fuel injected into the combustion chamber completely reacts with the oxygen and the maximum temperature at the time of combustion becomes higher. A high maximum temperature at the time of combustion means a greater amount of NOx produced by combustion, so it is preferable to lower this maximum temperature as much as possible. For this reason, the swirl control valve 35 is controlled to increase or decrease the swirl ratio from the optimum swirl ratio to an extent not causing misfires etc. Due to this, good combustion is not achieved and the maximum temperature at the time of combustion falls.

Further, for example, if reducing the swirl ratio from the optimum value, the amount of intake air is reduced, so there is insufficient oxygen required for combustion and the maximum temperature at the time of combustion falls. However, as a result, the particulate matter in the exhaust gas increases, but this is trapped by the particulate filter 25, so deterioration of the exhaust properties is prevented. On the other hand, if increasing the swirl ratio from the optimum value, the flow of gas in the combustion chamber 5 becomes faster and therefore ignition becomes harder and the maximum temperature at the time of combustion falls. However, as a result, the unburned HC and CO increases, but when the oxidation catalyst 23 is activated, these are oxidized by the oxidation catalyst 23, so deterioration of the exhaust properties is prevented.

Due to the above, by increasing or decreasing the swirl ratio, it becomes possible to lower the maximum temperature at the time of combustion and reduce the amount of production of NOx. At this time, it is possible to determine whether to increase or decrease the swirl ratio in accordance with the active state of the oxidation catalyst 23. That is, reduction of the swirl ratio is possible without regard as to the active state of the oxidation catalyst 23 since the exhaust properties are maintained if trapping the increased particulate matter in the exhaust gas by a particulate filter. However, if increasing the swirl ratio, if the oxidation catalyst 23 is not in the active state, unburned HC will be exhausted into the atmosphere which is not preferable. Therefore, the swirl ratio can be increased only when the oxidation catalyst 23 is active.

As another means for adjusting the swirl ratio, for example, a variable valve timing mechanism may be utilized. That is, one of the two intake valves 7, for example, the intake valve 7 at the branch tube 11b side, is provided with a variable valve timing mechanism in the same way as the swirl control valve 35 shown in FIG. 5, FIGS. 6a and 6b. Here, the valve opening operation is determined by for example one or more of the amount of lift, valve opening period (operating angle), and valve opening starting timing. The mechanism of the present embodiment will not be described in detail since any known mechanism can be used.

Further, for example, by using the variable valve timing mechanism to adjust the amount of lift of the intake valve 7 at the branch tube 11b side and reduce the amount of intake air, it becomes possible to produce a swirl similar to that shown by the arrow in FIG. 6b. The swirl ratio is determined by adjusting the amount of lift.

In this regard, when reducing and purifying the stored NOx, the air-fuel ratio will inevitably change as shown in FIG. 4, so the possibility of production of N₂O is the greatest. Therefore, next, the N₂O production suppression rich processing according to the present invention will be explained for the case of use for reduction and purification of NOx stored in the NOx storing reducing catalyst 24.

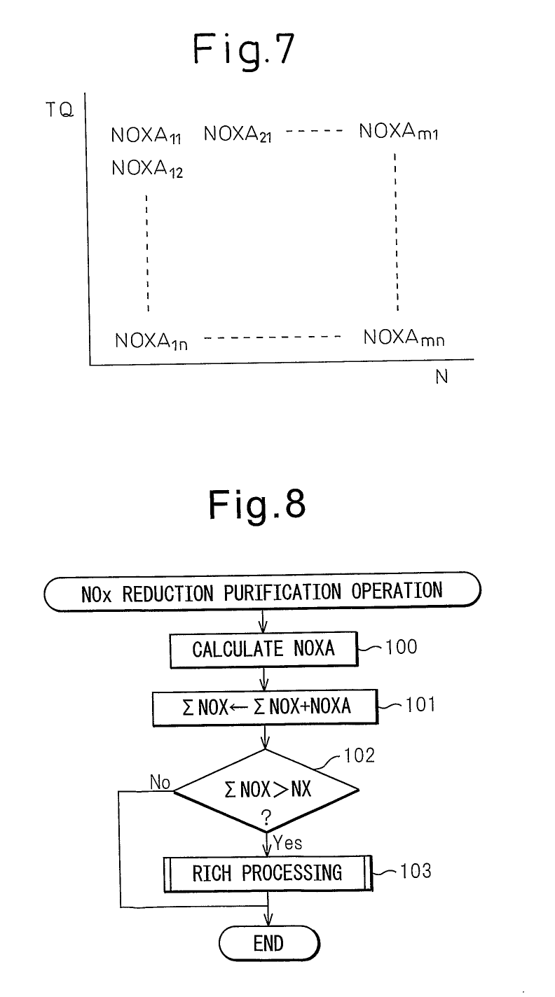

In the embodiments according to the present invention, the NOx amount NOXA stored in the NOx storing reducing catalyst 24 per unit time is stored as a function of the required torque TQ and engine speed N in the form of a map shown in FIG. 7 in advance in the ROM 42. By cumulatively adding this NOx amount NOXA, the NOx amount ΣNOX stored in the NOx storing reducing catalyst 24 is calculated. Rich processing is performed each time this NOx amount ΣNOX reaches the allowable value NX, whereby the NOx is reduced and purified from the NOx storing reducing catalyst 24.

FIG. 8 is a flow chart of an NOx reduction purification operation for reducing and purifying NOx stored in the NOx storing reducing catalyst 24. This operation is performed as a routine executed by interruption every predetermined set time interval by the electronic control unit (ECU) 40.

First, at step 100, the NOx amount NOXA stored per unit time is calculated from the map shown in FIG. 7. Next at step 101, the NOXA calculated at step 100 is added to the NOx amount ΣNOX stored in the NOx storing reducing catalyst 24. Next at step 102, it is judged if the stored NOx amount ΣNOX is over the allowable value NX. When the stored NOx amount ΣNOX is the allowable value NX or less, the routine is ended without performing rich processing. On the other hand, when the stored NOx amount ΣNOX is larger than the allowable value NX, the routine proceeds to step 103 where the later explained rich processing is performed and the routine is ended.

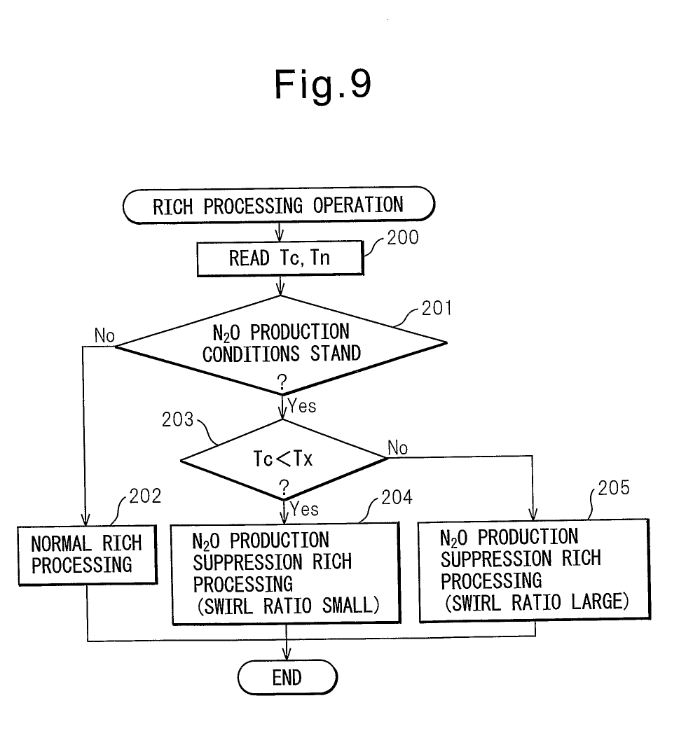

FIG. 9 is a flow chart of a rich processing operation. This operation is performed as a routine executed at step 103 of the NOx reduction purification operation shown in FIG. 8, but it may also be performed in other cases according to the engine operating conditions where it is anticipated that the air-fuel ratio of the exhaust gas flowing into the NOx storing reducing catalyst 24 will temporarily become rich.

First, at step 200, the catalyst temperature Tc of the oxidation catalyst 23 and the catalyst temperature Tn of the NOx storing reducing catalyst 24 are read. Next, at step 201, it is judged if the N₂O production conditions stand. The condition (1) of the above-mentioned N₂O production conditions is satisfied by the later rich processing. Therefore, the N₂O production conditions stand when the catalyst temperature Tn of the NOx storing reducing catalyst 24 read at step 200 is in the N₂O production temperature range (condition (2)) and the NOx amount NOXA calculated from the map shown in FIG. 7 is the allowable value NL or more (condition (3)).

At step 201, when the N₂O production conditions do not stand, that is, when the catalyst temperature Tn of the NOx storing reducing catalyst 24 is not in the N₂O production temperature range and/or the NOx amount NOXA is less than an allowable value NL, the routine proceeds to step 202. Next at step 202, normal rich processing is performed without performing the N₂O production suppression rich processing and the routine is ended.

On the other hand, at step 201, when the N₂O production conditions stand, that is, when the catalyst temperature Tn of the NOx storing reducing catalyst 24 is in the N₂O production temperature range and the NOx amount NOXA is the allowable value NL or more, the routine proceeds to step 203. Next at step 203, it is judged if the catalyst temperature Tc of the oxidation catalyst 23 is smaller than the activation temperature Tx.

When, at step 203, the catalyst temperature Tc of the oxidation catalyst 23 is smaller than the activation temperature Tx, the routine proceeds to step 204. Next, at step 204, the swirl ratio is reduced from the optimum value for N₂O production suppression rich processing and the routine is ended. The particulate matter in the exhaust gas increased during the rich processing is trapped by the particulate filter 25.

On the other hand, when, at step 203, the catalyst temperature Tc of the oxidation catalyst 23 is the activation temperature Tx or more, the routine proceeds to step 205. Next, at step 205, the swirl ratio is increased from the optimum value for N₂O production suppression rich processing and the routine is ended. The HC in the exhaust gas increased during the rich processing is oxidized in the oxidation catalyst 23.

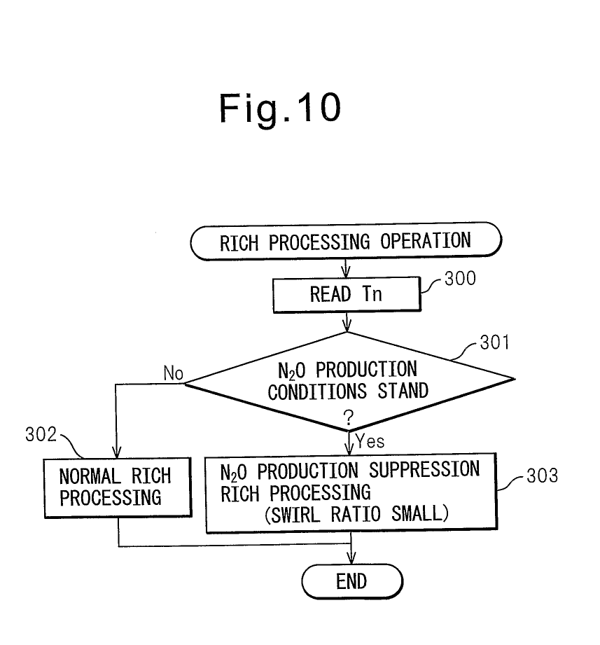

As explained above, the method of reducing the swirl ratio to reduce the amount of production of NOx can be used regardless of the active state of the oxidation catalyst 23 from the viewpoint of the exhaust properties. Therefore, as shown in FIG. 10 partially changing part of the rich processing operation shown in FIG. 9, when, at step 301, the N₂O production conditions stand, next, at step 303, the swirl ratio is reduced from the optimum value for N₂O production suppression rich processing and the routine is ended.

Note that, in the present embodiment, to adjust the disturbance of the gas in the combustion chamber 5, the swirl control valve 35 was used to control the swirl ratio, but other means may also be used if able to adjust the disturbance of the gas in the combustion chamber 5 and able to control to a certain extent the amount of intake air supplied into the combustion chamber 5 (that is, if able to act as a venturi). As such a means, for example, a tumble control valve etc. may be considered. When using other means, the increase or decrease of the swirl ratio in the present embodiment corresponds to the increase or decrease of the disturbance.

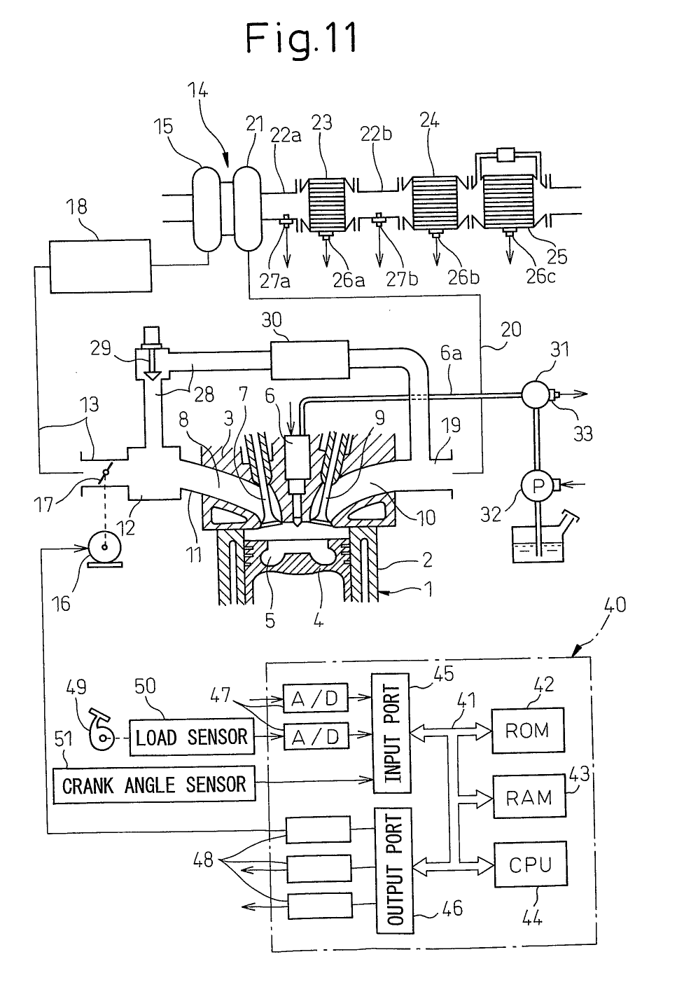

Next, a second embodiment shown in FIG. 11 will be explained. The compression ignition type internal combustion engine shown in the present embodiment is configured the same as the first embodiment shown in FIG. 1 except for the point of not having a swirl control valve drive actuator and swirl control valve.

In the second embodiment, as the NOx production reducing control, the amount of EGR gas recirculated to a combustion chamber 5 is increased to reduce the amount of NOx. Usually, during rich processing, the amount of EGR gas recirculated is reduced or stopped so as to prevent the formation of deposits made of mainly solid carbon in the EGR passage 28 and the electrically controlled EGR control valve 29 due to the exhaust gas containing a large amount of hydrocarbons etc. However, in the present embodiment, at least in the period where the air-fuel ratio of the exhaust gas flowing into the NOx storing reducing catalyst switches from lean to rich and the period where it switches from rich to lean, that is, the NOx production reducing period 1 shown in FIG. 4, the EGR gas is increased and the amount of production of NOx is reduced. In the NOx production reducing period 2 shown in FIG. 4 as well, when production of a large amount of N₂O is anticipated etc., it is also possible to give priority to the suppression of the amount of N₂O due to the production of deposits, increase the EGR gas, and reduce the amount of NOx.

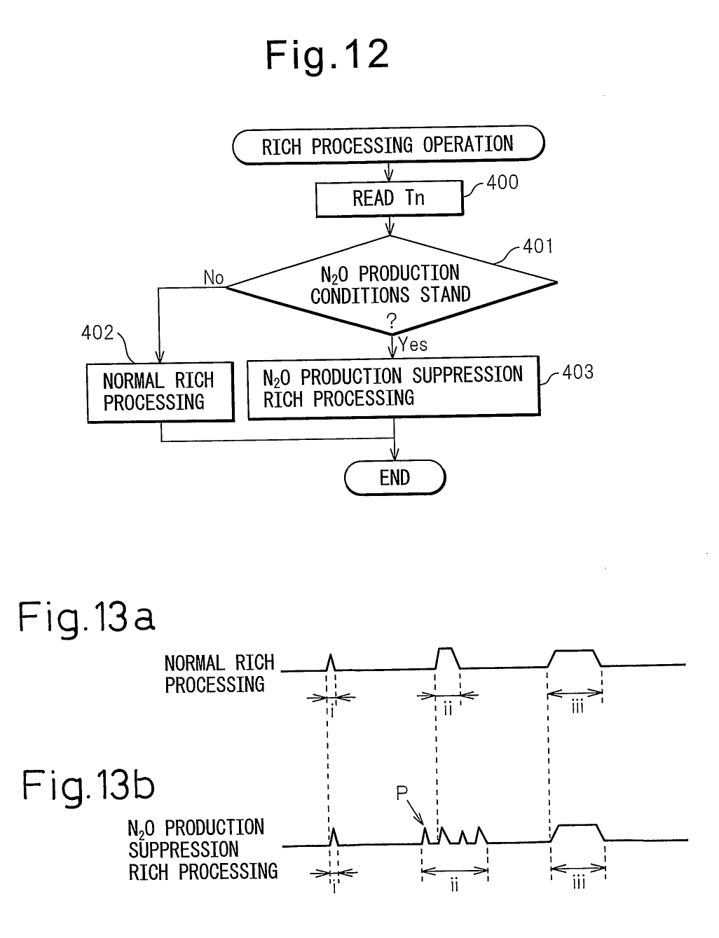

FIG. 12 is a flow chart of a rich processing operation. This operation is performed as a routine executed at step 103 of the NOx reduction purification operation shown in FIG. 8. It may also be performed in other cases when, depending on the engine operating conditions, it is anticipated that the air-fuel ratio of the exhaust gas flowing into the NOx storing reducing catalyst 24 will temporarily become rich.

First, at step 400, the catalyst temperature Tn of the NOx storing reducing catalyst 24 is read. Next, at step 401, it is judged if the N₂O production conditions stand. The condition (1) of the above-mentioned N₂O production conditions is satisfied by the later rich processing. Therefore, the N₂O production conditions stand when the catalyst temperature Tn of the NOx storing reducing catalyst 24 read at step 400 is in the N₂O production temperature range (condition (2)) and the NOx amount NOXA calculated from the map shown in FIG. 7 is the allowable value NL or more (condition (3)).

At step 401, when the N₂O production conditions do not stand, that is, when the catalyst temperature Tn of the NOx storing reducing catalyst 24 is not in the N₂O production temperature range and/or the NOx amount NOXA is less than an allowable value NL, the routine proceeds to step 402. Next at step 402, normal rich processing is performed without performing the N₂O production suppression rich processing and the routine is ended.

On the other hand, at step 401, when the N₂O production conditions stand, that is, when the catalyst temperature Tn of the NOx storing reducing catalyst 24 is in the N₂O production temperature range and the NOx amount NOXA is an allowable value NL or more, the routine proceeds to step 403. Next at step 403, the EGR gas is increased for N₂O production suppression rich processing and the routine is ended.

Next, a third embodiment will be explained. The compression ignition type internal combustion engine shown in the present embodiment is configured the same as the second embodiment shown in FIG. 11.

In the third embodiment, as the NOx production reducing control, the fuel to be injected for each engine cycle is injected divided into several injections so as to lower the maximum temperature at the time of combustion and reduce the amount of production of NOx. In regard to this, FIGS. 13a and 13b show the change in the amount of lift of the needle for adjusting the amount of injection of fuel by the fuel injector 6 at the time of the N₂O production suppression rich processing. FIG. 13a shows the change of the amount of lift of the needle at the time of normal rich processing. In the figure, the injection in the injection period I is a first sub injection for creating an air-fuel mixture in advance in the combustion chamber so as to facilitate combustion, the injection in the injection period ii is the main injection where fuel is mainly injected near top dead center of compression so as to obtain output from the internal combustion engine, and the injection in the injection period iii is a second sub injection where fuel is mainly injected during the expansion stroke of combustion by the main injection so as to adjust the air-fuel ratio of the exhaust gas and make the air-fuel ratio of the exhaust gas rich.

FIG. 13b shows the change in the amount of lift of the needle in the N₂O production suppression rich processing in the present embodiment. Compared with during the normal rich processing shown in FIG. 13a, the fuel to be injected in the main injection is divided and injected split among several injections. That is, by injecting the fuel divided, the combustion period by the main injection becomes longer and therefore the maximum temperature at the time of combustion becomes lower compared with the normal main injection injecting all of the fuel at one time. As a result, the amount of production of NOx can be reduced.

Further, by dividing the main injection into a plurality of injections, there is also the advantage that even in the main injection shown by P in the injection period ii, the initial injection is mainly utilized for creating a spark inside combustion chamber, while the latter injection of the main injection is utilized for improvement of the ignitability in the second sub injection and promotion of combustion by diffusion inside the combustion chamber.

The present embodiment may utilize an operation similar to the rich processing operation shown in FIG. 12 explained in the second embodiment. That is, as the N₂O production suppression rich processing at step 403, the fuel to be injected is divided for injection according to the present embodiment for the N₂O production suppression rich processing.

Next, a fourth embodiment will be explained. The compression ignition type internal combustion engine shown in the present embodiment is configured the same as the second embodiment shown in FIG. 11.

In the fourth embodiment, as the NOx production reducing control, the injection pressure of the fuel injected from the fuel injector is reduced to reduce the maximum temperature at the time of combustion and reduce the amount of production of NOx. That is, if reducing the injection pressure of the fuel, the fuel becomes insufficiently atomized compared with the time of normal injection pressure. As a result, the combustion becomes incomplete compared with injection by normal fuel injection pressure and the maximum temperature at the time of combustion also falls. Due to this, the production of NOx is reduced and the amount of production of N₂O can be suppressed. Note that, the fuel injection pressure is adjusted by controlling the discharge rate of the fuel pump 32.

The present embodiment may utilize an operation similar to the rich processing operation shown in FIG. 12 explained in the second embodiment. That is, as the N₂O production suppression rich processing at step 403, the fuel injection pressure is reduced for injection according to the present embodiment for N₂O production suppression rich processing.

Note that, in each of the above embodiments, to reliably suppress the production of N₂O, it is also possible to set the allowable value NL of the NOx amount NOXA, one of the N₂O production conditions, to zero. Further, it is also possible to use the above four embodiments in any combination.

In the above-mentioned embodiments, as the method for reducing the amount of NOx produced by combustion in the combustion chamber for suppress the production of N₂O, several methods mainly comprising reducing the maximum temperature at the time of combustion were explained. However, in the present invention, other methods of reducing the maximum temperature able to be used for reducing the amount of NOx or methods other than reducing the amount of NOx to reduce the maximum temperature can be utilized.

Note that the present invention was explained in detail based on specific embodiments, but a person skilled in the art could make various changes, modifications, etc. without departing from the claims and idea of the present invention.

Further, the present application was filed along with a claim of priority based on Japanese Patent Application No. 2008-286426 filed on Nov. 7, 2008, the entire content of which basic application is incorporated by reference in the present specification.

1-7. (canceled)

8. An exhaust purification system of an internal combustion engine arranging in an engine exhaust passage an NOx storing reducing catalyst storing NOx contained in exhaust gas when an air-fuel ratio of inflowing exhaust gas is lean and reducing and purifying stored NOx when the air-fuel ratio of the inflowing exhaust gas becomes a stoichiometric air-fuel ratio or rich, which exhaust purification system of an internal combustion engine is provided with an NOx production reducing means for reducing an amount of production of NOx produced in a combustion chamber due to change of a combustion state of the engine and temporarily reduces the amount of production of NOx by the NOx production reducing means at least when a catalyst temperature of the NOx storing reducing catalyst is within an N₂O production temperature range in a period where the air-fuel ratio of the exhaust gas flowing into the NOx storing reducing catalyst is switched from lean to rich and a period in which it is switched from rich to lean.

9. An exhaust purification system of an internal combustion engine as set forth in claim 8 in which in the period at which the air-fuel ratio of the exhaust gas flowing into the NOx storing reducing catalyst is switched from lean to rich to the period in which it is switched from rich to lean, when the catalyst temperature of the NOx storing reducing catalyst is within an N₂O production temperature range, said NOx production reducing means temporarily reduces the amount of production of NOx.

10. An exhaust purification system of an internal combustion engine as set forth in claim 8 in which in the period at which the air-fuel ratio of the exhaust gas flowing into the NOx storing reducing catalyst is switched from lean to rich and the period in which it is switched from rich to lean, when the catalyst temperature of the NOx storing reducing catalyst is within an N₂O production temperature range, said NOx production reducing means temporarily reduces the amount of production of NOx and, between these periods, said NOx production reducing means does not temporarily reduce the amount of production of NOx.

11. An exhaust purification system of an internal combustion engine as set forth in claim 8 wherein the system is further provided with an intake flow adjusting means for adjusting an intake flow to the inside of a combustion chamber and forming an optimum disturbance of gas in accordance with an engine operating state inside the combustion chamber and said NOx production reducing means controls said intake flow adjusting means to form a disturbance different from the optimum disturbance of the gas and thereby reduce the amount of production of NOx produced in the combustion chamber.

12. An exhaust purification system of an internal combustion engine as set forth in claim 11 wherein the system further arranges in the engine exhaust passage an oxidation catalyst and a particulate filter for trapping particulate matter in the exhaust gas, and said NOx production reducing means controls said intake flow adjusting means, forms a disturbance reduced from the optimum disturbance of the gas, and traps the particulate matter in the exhaust gas increased due to combustion due to the disturbance by the particulate filter.

13. An exhaust purification system of an internal combustion engine as set forth in claim 12 wherein at the time of activation of the oxidation catalyst, said NOx production reducing means controls said intake flow adjusting means, forms a disturbance increased from the optimum disturbance of the gas, and oxidizes the hydrocarbons in the exhaust gas increased due to combustion by that disturbance by the oxidation catalyst.

14. An exhaust purification system of an internal combustion engine as set forth in claim 8 wherein the system is further provided with an exhaust gas recirculation passage for recirculating part of the exhaust gas in the engine exhaust passage to the engine intake passage and said NOx production reducing means reduces the amount of production of NOx produced in the combustion chamber due to the increase in the amount of exhaust gas recirculated to the combustion chamber.

15. An exhaust purification system of an internal combustion engine as set forth in claim 8 wherein the system is further provided with a fuel injecting means for injecting fuel into a combustion chamber and an injection pressure adjusting means for adjusting the fuel injection pressure of the fuel injecting means, and said NOx production reducing means controls said injection pressure adjusting means and lowers the fuel injection pressure so as to reduce the amount of production of NOx produced in the combustion chamber.

16. An exhaust purification system of an internal combustion engine as set forth in claim 8 wherein the system is further provided with a fuel injecting means for injecting fuel into a combustion chamber and a division adjusting means for dividing the fuel which said fuel injecting means should inject for each engine cycle into a plurality of injections, and said NOx production reducing means reduces the amount of production of NOx produced inside the combustion chamber by controlling said division adjusting means and dividing the fuel to be injected every engine cycle into a plurality of injections.
